(19) United States
(12) Patent Application Publication
(10) Pub. No.: US 2017/0083349 A1
(43) Pub. Date: Mar. 23, 2017

(54) DRAWING SOFTWARE

(71) Applicant: Mitsubishi Electric Corporation, Tokyo (JP)

(72) Inventors: Tomohiro IWAKI, Tokyo (JP); Rika HIGASHI, Tokyo (JP)

(73) Assignee: Mitsubishi Electric Corporation, Tokyo (JP)

(21) Appl. No.: 15/308,524

(22) PCT Filed: Jun. 11, 2014
(86) PCT No.: PCT/JP2014/065495

§ 371 Date: Nov. 2, 2016

(51) Int. Cl. G06F 9/44

(52) U.S. Cl. CPC G06F 9/4446; G06F 3/0484

(57) ABSTRACT

A drawing software causes a computer to function as a wizard control unit and a highlighting-shift control unit. The wizard control unit stores, in a storage unit, function-dependency relation data that indicates the setting order of a plurality of sub-functions included in a function of a programmable display device, stores, in the storage unit, setting-item dependency relation data that indicates the setting order of respective setting items on a setting screen of a sub-function, displays, on a display unit, a list of a plurality of sub-functions having assigned numbers based on the function-dependency relation data, and displays, on the display unit, a setting screen of a sub-function selected from among the displayed list of the sub-functions. The highlighting-shift control unit sequentially highlights respective setting items on the setting screen of the sub-function on the basis of the setting-item dependency relation data.

### FIELD

The present invention relates to a drawing software.

### BACKGROUND

A programmable display device is typically connected to external devices such as a programmable logic controller (PLC), and is used to collect and display various types of data from these external devices, and to control the external devices.

Thus, generally, a project-data creation device that is an engineering tool for a programmable display device is used to create project data by setting various functions such as an alarm function, a data display and input function, a graph display function, and a recipe function, order to cause the programmable display device to collect data from an external device, display the state of the external device, and control the external device. The project-data creation device is formed by causing a computer to execute the drawing software.

In recent years, as a programmable display device has advanced functions, a single function is often configured by a plurality of associated sub-functions. Thus, a project-data creation device, in many cases, settings related to the function of the programmable display device cannot be completed only on a single screen, and the settings need to be performed across a plurality of sub-function setting screens. Further, as the programmable display device has the advanced functions, the number of setting items on the sub-function setting screen increases, which complicates the setting order.

Those problems have been addressed by taking measures, such as switching to another sub-function setting screen, i.e., placing a switching button in the setting dialog for switching to another sub-function setting screen, or preventing the setting of an item, for example, displaying in grey an item that cannot be set unless another item has already been set on the sub-function setting screen.

Patent Literature 1 discloses a technique of automatically generating a screen of a programmable display device on the basis of the hardware-configuration information and the logical-configuration information that identifies which of a plurality of device groups the programmable display device belongs to.

### CITATION LIST

### Patent Literature

Patent Literature 1: Japanese Patent Application Laid-open No. 2004-30345

### SUMMARY

### Technical Problem

There are the following problems in the above measures, i.e., the placement of the switching button in the setting dialog for switching to another sub-function setting screen, and the display of the item in grey that cannot be set unless another item has already been set on the sub-function setting screen. First, even when the switching button is placed in the setting dialog, all the associated sub-functions cannot be recognized, and therefore a setting omission and a setting error are more likely to occur. Second, even though the setting is prevented from being performed unless another item has already been set on the sub-function setting screen, a considerable amount of time is still required for the settings because the relation between the setting items and the setting order are not displayed. Consequently, it is still difficult to create project data easily even when the switching button for switching to another sub-function setting screen is placed in the setting dialog, or the item that cannot be set unless another item has already been set on the sub-function setting screen is displayed in grey.

Further, when a screen is automatically created by the project-data creation device, as in the invention disclosed in Patent Literature 1, a user cannot learn what procedure he should follow to proceed with the settings as the user uses a normal setting screen to perform the settings. Furthermore, only one part of the setting details cannot be changed. Nor can a user learn that details of which item on which setting screen should be changed to change only one part of the setting details. Therefore, the automatic screen creation cannot contribute to improvement in user's skills in creating the project data.

The present invention has been achieved in view of the foregoing, and an object of the present invention is to provide a drawing software that makes it easier to create project data and can contribute to improvement in user's skills in creating the project data.

### Solution to Problem

To solve the above problem and achieve the object, the present invention provides a drawing software that causes a computer including a display unit and a storage unit to function as a project-data creation device that creates project data for a programmable display device that displays a state of an external device and controls the external device. The software causes the computer to function as: means for storing, in the storage unit, first information indicating a setting order of a plurality of sub-functions included in a function of the programmable display device; means for storing, in the storage unit, second information indicating a setting order of respective setting items on a setting screen of a sub-function; means for displaying, on the display unit, a list of a plurality of sub-functions having assigned numbers based on the first information; means for displaying, on the display unit, a setting screen of a sub-function selected from among the displayed list of the sub-functions; and means for sequentially highlighting the respective setting items on the setting screen of the sub-function on a basis of the second information.

### Advantageous Effects of Invention

The drawing software according to the present invention provides effects of making it easier to create project data and contributing to improvement in user's skills in creating the project data.

### BRIEF DESCRIPTION OF DRAWINGS

FIG. 1 is a diagram illustrating the configuration of a project-data creation device according to a first embodiment of the present invention.

FIG. 2 is a diagram illustrating a configuration of a computer applied to the project-data creation device.

FIG. 3 is a diagram illustrating a functional configuration of the project-data creation device.

FIG. 4 is a flowchart illustrating a flow of operations of the project-data creation device according to the first embodiment.

FIG. 5 is a diagram illustrating an example of the function-setting wizard screen.

FIG. 6 is a diagram illustrating an example of function-dependency relation data.

FIG. 7 is a diagram illustrating an example of setting-item dependency relation data.

FIG. 8 is a conceptual diagram illustrating transition.

of highlighted setting items.

FIG. 9 is a diagram illustrating an example of transition of a setting screen of a historical trend graph.

FIG. 10 is a diagram illustrating an example of a sub-function setting screen of a project-data creation device according to a second embodiment.

### DESCRIPTION OF EMBODIMENTS

Embodiments of drawing software according to the present invention will be explained below in detail with reference to the accompanying drawings. The present invention is not limited to the embodiments.

### First Embodiment

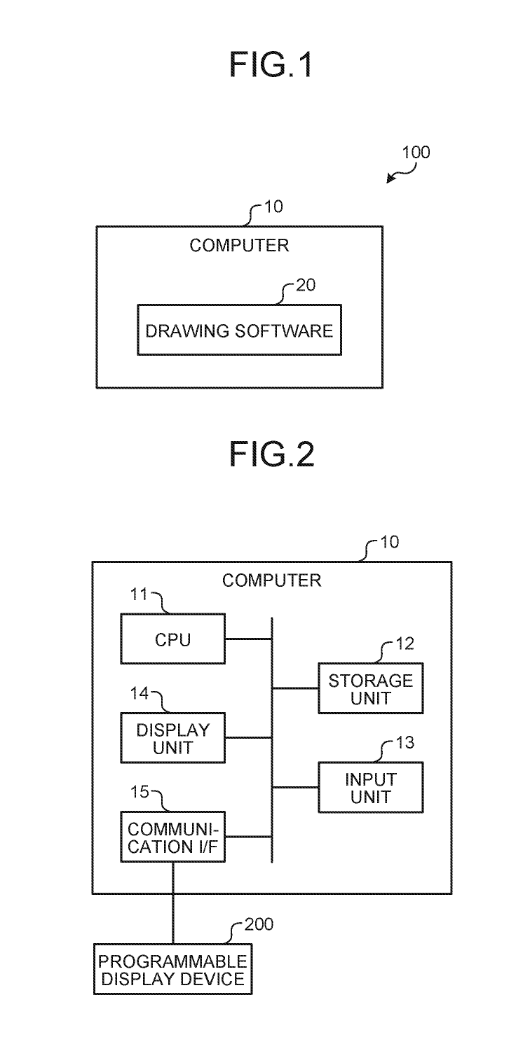

FIG. 1 is a diagram illustrating the configuration of a project-data creation device according to a first embodiment of the present invention. A project-data creation device 100 is configured by executing a drawing software 20 by a computer 10. In other words, the computer 10 that is executing the drawing software 20 serves as the project-data creation device 100.

FIG. 2 is a diagram illustrating a configuration of a computer applied to the project-data creation device. The computer 10 includes a CPU 11, a storage unit 12, an input unit 13, a display unit 14, and a communication interface (I/F) 15. A plurality of functional units are configured on the computer 10 by executing the drawing software 20 by the CPU 11. The input unit 13 is an input device such as a keyboard and a mouse. The display unit 14 is a display device such as a liquid-crystal display device. The communication I/F 15 is an interface to communicate with a programmable display device 200.

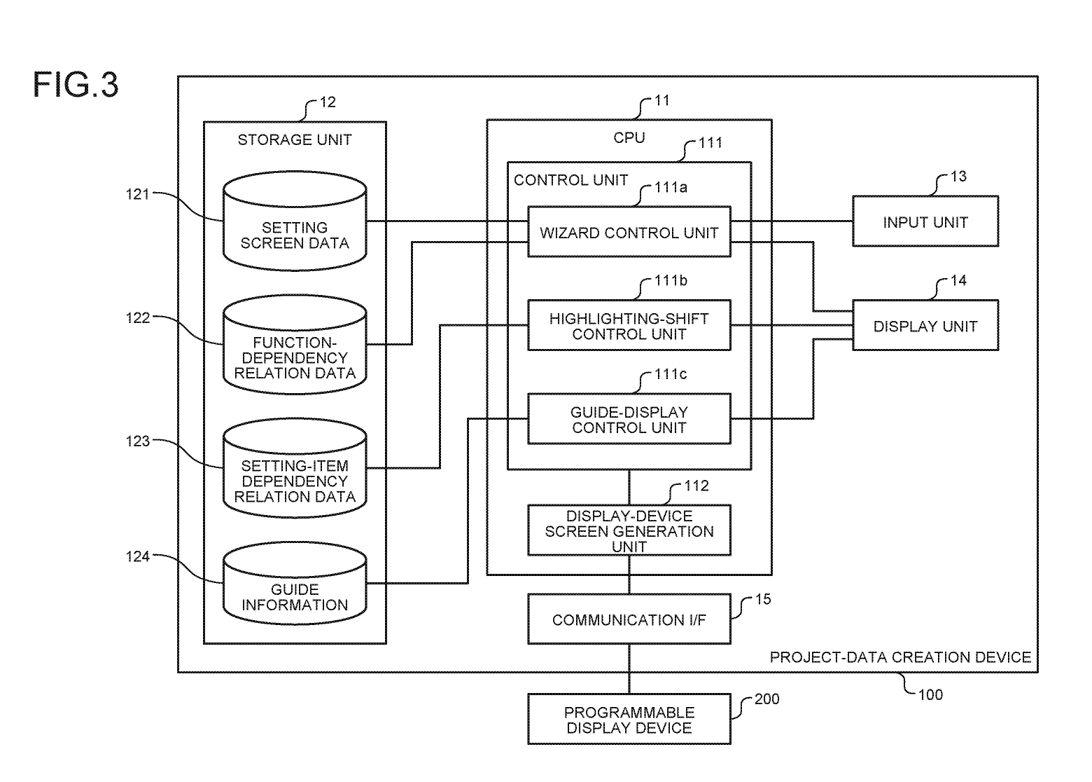

FIG. 3 is a diagram illustrating a functional configuration of the project-data creation device. In the CPU 11, a control unit 111 and a display-device screen generation unit 112 are formed. The storage unit 12 setting screen data 121, function-dependency relation data 122, setting-item dependency relation data 123, and guide information 124, all of which are stored therein. At the startup of the drawing software 20, a wizard control unit 111a stores the setting screen data 121, the function-dependency relation data 122, the setting-item dependency relation data 123, and the guide information 124 in the storage unit 12.

The control unit 111 includes the wizard control unit 111a, a highlighting-shift control unit 111b, and a guide-display control unit 111c. The wizard control unit 111a executes the processing related to a function-setting wizard described later. During execution of the function-setting wizard, the highlighting-shift control unit 111b highlights a setting item on a sub-function setting screen on the basis of the setting-item dependency relation data 123. The guide-display control unit 111c reads the guide information 124 related to the setting item highlighted by the highlighting-shift control unit 111b, and displays a description text included in the guide information 124. The display-device screen generation unit 112 creates project data on the programmable display device 200 on the basis of each setting item that is set by the function-setting wizard.

The setting screen data 121 includes a function-setting wizard screen described later in addition to data on the sub-function setting screen. The function-dependency relation data 122 is the first information that indicates a dependency relation between sub-functions specified in the specifications of the drawing software 20 and the programmable display device 200. The setting-item dependency relation data 123 is the second information that indicates a dependency relation between setting items specified in the specifications of the drawing software and the programmable display device. The guide information 124 is information including a description text that describes the meaning and purpose of the setting item. The function-dependency relation data 122 and the setting-item dependency relation data 123 are described later in detail.

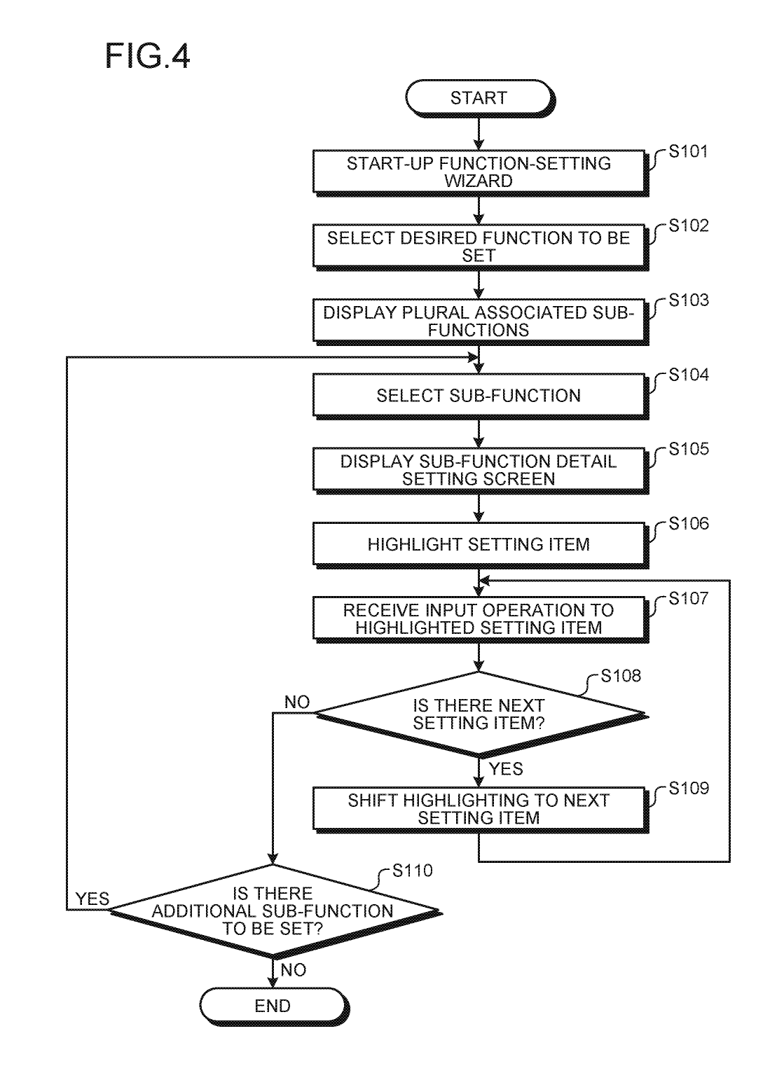

An operation of the project-data creation device according to the first embodiment is described. FIG. 4 is a flowchart illustrating a flow of operations of the project-data creation device 100 according to the first embodiment. First, the control unit 111 monitors performance of an operation on the input unit 13 to start the function-setting wizard. When this operation is performed, the control unit 111 operates the wizard control unit 111a (Step S101).

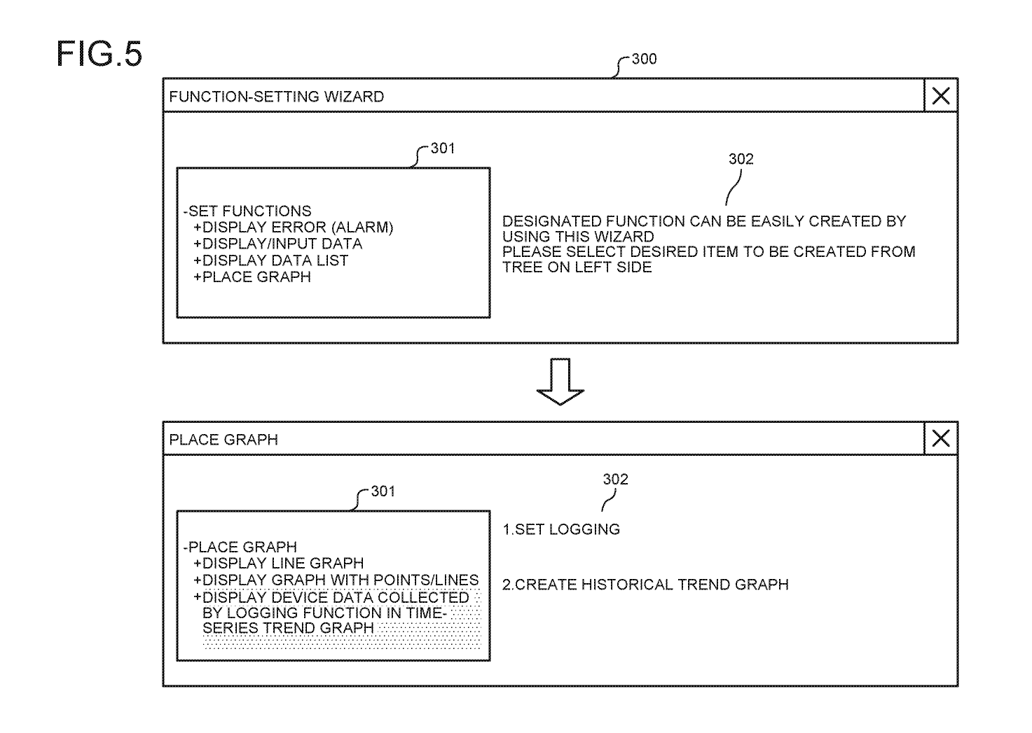

FIG. 5 is a diagram illustrating an example of the function-setting wizard screen. A function-setting wizard screen. 300 includes a tree display area 301 and a description-text display area 302. In the tree display area 301, functions that can be set by the function-setting wizard are displayed in a tree structure. Upon selecting any one of the functions, the lower-level hierarchy items are developed and displayed. When, on the tree display area 301, a function is selected at the lowest level of hierarchy (Step S102), the wizard control unit 111a displays sub-functions required for executing the selected function in the description-text display area 302 (Step S103). In the example illustrated in FIG. 5, in a state where the function of “displaying device data collected by the logging function in a time-series trend graph” is selected in the tree display area 301, the necessity of setting two items which are: logging setting; and creation of a historical trend graph is displayed in the description-text display area 302. The wizard control unit 111a simultaneously displays the numbers that indicate the setting order of the sub-functions in the description-text display area 302, on the basis of the function-dependency relation data 122.

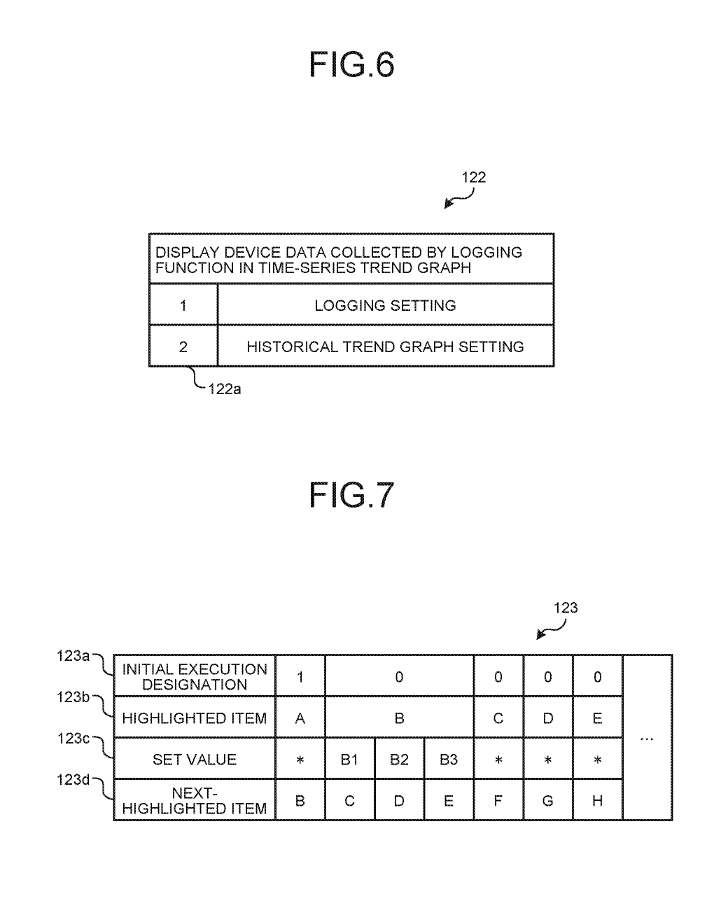

FIG. 6 is a diagram illustrating an example of the function-dependency relation data. The function-dependency relation refers to the setting order of sub-functions. The function-dependency relation data 122 is data that defines a function dependency relation. The illustrated function-dependency relation data 122 indicates that “the function of displaying device data collected by the logging function in a time-series trend graph” is configured by two sub-functions, which are the logging function and the historical trend graph function. Further, the necessity of first performing the logging setting, and next creating a historical trend graph, is defined by the numbers 122a.

When an operation of selecting either of the sub-functions displayed in the description-text display area 302 is performed through the input unit 13 (Step S104), the wizard control unit 111a reads data on a setting screen of the selected sub-function from the setting screen data 121, and displays the read data on the display unit 14 (Step S105). The highlighting-shift control unit 111b highlights a setting item on the sub-function setting screen on the basis of the setting-item dependency relation data 123 (Step S106). For example, the highlighting-shift control unit 111b displays, in the entry field, a different-colored box from the background color, in order to highlight an item that should be set at the current stage. The highlighting-shift control unit 111b receives an input operation performed on the highlighted setting item by a user using the input unit 13 (Step S107).

The setting-item dependency relation data 123, and a process of shifting a setting item to be highlighted, on the basis of this setting-item dependency relation data 123, are described. The setting-item dependency relation refers to the setting order of respective setting items on the sub-function setting screen. The setting-item dependency relation data 123 is data that defines a setting-item dependency relation. FIG. 7 is a diagram illustrating an example of the setting-item dependency relation data. The setting-item dependency relation data 123 shows the setting order recommended by a creator of the setting-item dependency relation data 123 on the sub-function setting screen. The creator of the setting-item dependency relation data 123 is, for example, a vendor of the drawing software 20. The setting-item dependency relation data 123 includes an initial execution designation 123a, a highlighted item 123b, a set value 123c, and a next-highlighted item 123d. In FIG. 7, an asterisk in the field of the set value 123c represents no relation with the setting details. For example, when a setting item A is highlighted, the asterisk indicates that the next-highlighted item is a setting item B regardless of what has been set in the setting item A. The value “1” in the field of the initial execution designation 123a indicates the setting item that is highlighted when the sub-function setting screen is initially displayed. The value “0” indicates the setting item that is not highlighted when the sub-function setting screen is initially displayed.

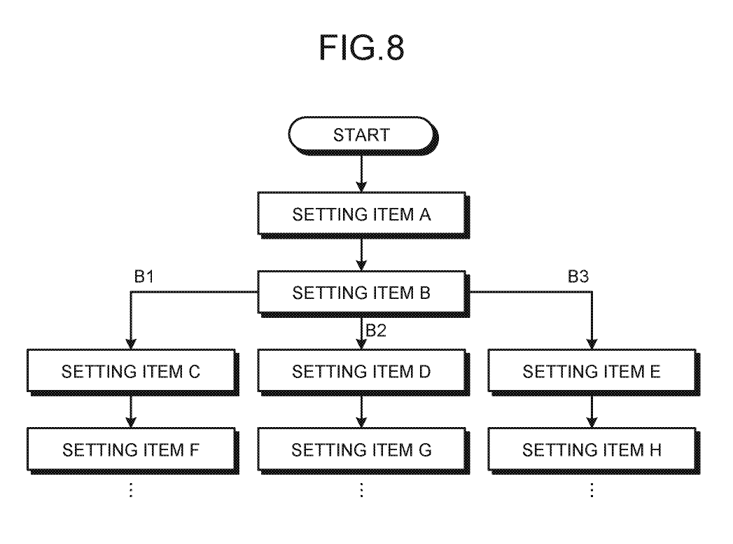

FIG. 8 is a conceptual diagram illustrating transition of highlighted setting items. When the sub-function setting screen is initially displayed, the highlighting-shift control unit 111b highlights the setting item A in accordance with the value in the field of the initial execution designation 123a. Because the asterisk is shown in the set value 123c of the setting item A, the highlighting control unit 111b subsequently highlights the setting item B regardless of the setting details. For the setting item. B, there are three set values B1, B2, and B3. The next-highlighted setting item varies in accordance with the setting details. That is, when the set value B1 is set in the setting item B, the highlighting-shift control unit 111b subsequently highlights a setting item C. When the set value B2 is set in the setting item B, the highlighting-shift control unit 111b subsequently highlights a setting item D. When the set value B3 is set in the setting item B, the highlighting-shift control unit lllb subsequently highlights a setting item F. Because the asterisk is shown in the set-value field of the setting item C, the highlighting-shift control unit 111b subsequently highlights a setting item. F regardless of the setting details. Further, because the asterisk is shown in the set-value field of the setting item D, the highlighting-shift control unit 111b subsequently highlights a setting item G regardless of the setting details. Furthermore, because the asterisk is shown in the set-value field of the setting item E, the highlighting-shift control unit 111b subsequently highlights a setting item. H regardless of the setting details.

As described above, the setting-item dependency relation data 123 includes the branched setting orders about the next-highlighted setting item that varies in accordance with the setting details. In the above example, the setting order “setting item A→setting item B→setting item C→setting item F . . . ”, the setting order “setting item A→setting item B→setting item D→setting item. G . . . ”, and the setting order “setting item A→setting item B→setting item E→setting item H . . . ”, are included in the setting-item dependency relation data 123. Thus, the highlighting-shift control unit 111b can still highlight the setting item even on a sub-function setting screen that includes a setting item having the setting details in accordance with which the next-highlighted setting item varies.

In the case where a setting operation is performed in the order that does not correspond to any of the setting orders defined in the setting-item dependency relation data 123, the highlighting-shift control unit 111b stops highlighting the setting item.

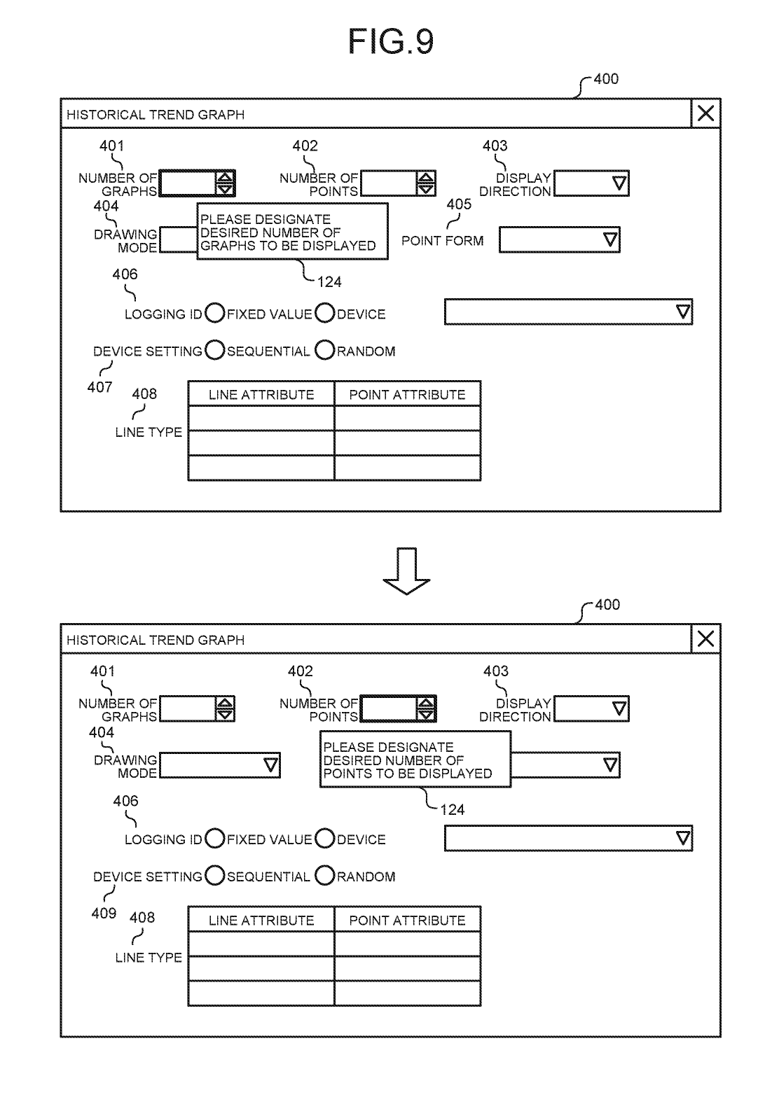

FIG. 9 is a diagram illustrating an example of transition of a setting screen of a historical trend graph. A historical-trend-graph setting screen 400 includes a plurality of setting items such as the number of graphs 401, the number of points 402, a display direction 403, a drawing mode 404, a point form. 405, a logging ID 406, a device setting 407, and a line type 408. The number of graphs 401 is designated as a setting item to be initially set. Thus, at the time of displaying the historical-trend-graph setting screen 400, the highlighting-shift control unit 11b initially highlights the setting item “the number of graphs 401”. Further, the guide-display control unit 111c reads from the storage unit 12 the guide information 124 regarding the highlighted “the number of graphs 401”, and displays the read guide information 124 on the historical-trend-graph setting screen 400. The simultaneous display of the guide information 124 at the time of highlighting the setting item enables a user to understand what the highlighted setting item means, and thus contributes to improvement in user's skills in creating project data.

Upon detecting that a setting operation has been performed on a certain setting item through the input unit 13, the highlighting-shift control unit 111b determines, on the basis of the setting-item dependency relation data 123, whether there is a setting item that should be next set (Step S108). When there is a setting item that should be next set (YES at Step S108), the highlighting-shift control unit 111b changes the setting item that is to be highlighted, to the next setting item in accordance with the setting-item dependency relation data 123 (Step S109), and then performs the operation at Step S107. In the case where the sub-function setting screen includes a plurality of tabs and a setting item to be next highlighted is in another tab, the highlighting-shift control unit 111b switches the tab to highlight the setting item that should be next highlighted. In the example in FIG. 9, in the setting-item dependency relation data 123, the number of points 402 is defined as a setting item that should be set next to the number of graphs 401. The highlighting-shift control unit 11b changes the setting item that is to be highlighted, to the field of “the number of points 402” in accordance with the setting-item dependency relation data 123. The guide-display control unit 111c reads from the storage unit 12 the guide information 124 regarding the highlighted “the number of points 402”, and displays the read guide information 124 on the historical-trend-graph setting screen 400.

For example, in a case where an item on which the setting is performed by radio buttons is highlighted, at the point in time when any of the radio buttons is selected, the highlighting-shift control unit 111b determines that the setting operation has just been performed, and then changes the setting item that is to be highlighted, in accordance with the setting-item dependency relation data 123. Similarly, in a case where an item on which the setting is performed by inputting a numerical value or a character string is highlighted, at the point in time when a predetermined time has elapsed after the input of a numerical value or a character string or at the point in time when the cursor is off, the highlighting-shift control unit 111 determines that the setting operation has just been performed, and then changes the setting item that is to be highlighted, in accordance with the setting-item dependency relation data 123.

When settings of all the setting items on the sub-function setting screen are completed (NO at Step S108), the wizard control unit determines, on the basis of the function-dependency relation data 122, whether there is an additional sub-function that should be set in executing the selected function (Step S110). When there is the additional sub-function that should be set in executing the selected function (YES at Step S110), the wizard control unit 111adisplays on the display unit 14 the function-setting wizard screen 300 including a list of sub-functions, and directs a user to perform an operation of selecting the next sub-function in the setting order in the function-dependency relation data 122 (Step S104).

When settings of all the sub-functions required for executing the selected function are completed (NO at Step S110), the wizard control unit 111a finishes the function-setting wizard.

As described above, the project-data creation device according to the first embodiment displays on the display unit a list of a plurality of sub-functions having the assigned numbers indicating the setting order of the sub-functions. The project-data creation device then displays, on the display unit, a setting screen of a sub-function selected from among the displayed list of sub-functions, and sequentially highlights the respective setting items on the sub-function setting screen on the basis of the setting-item dependency relation data that indicates the setting order of the respective setting items. At this time, the wizard control unit executes the function-setting wizard by using a normal sub-function setting screen. Thus, a user can learn what procedure he should follow to perform the settings when the function-setting wizard is not used. Accordingly, a user can achieve improvement in his/her skills in creating project data.

A user can set a switching operation of determining whether to highlight the setting item and display the guide information. 124. This prevents display of information that is unnecessary for experts, and can make it easier even for the experts to perform sub-function settings.

### Second Embodiment

The configuration of a project-data creation device according to a second embodiment is much the same as the configuration in the first embodiment. However, a setting screen of a sub-function involving a data flow is laid out in such a manner as to display setting-dialog calling buttons along the data flow. The sub-function involving the data flow is a sub-function of transmitting and receiving data to and from an external device such as a PLC.

In the following descriptions, a logging function is used as an example of the sub-function involving the data flow. The logging function is a function of collecting and accumulating a device value of a connected apparatus in the buffering area or the data storage at any timing or in any cycle. Thus, in the case of executing the logging function there is a data flow, that is, the device of the connected apparatus→the buffer area of the programmable display device→the data storage. Setting the logging function requires setting about three storage areas, which are the device of the peripheral apparatus, the buffer area of the programmable display device, and the data storage.

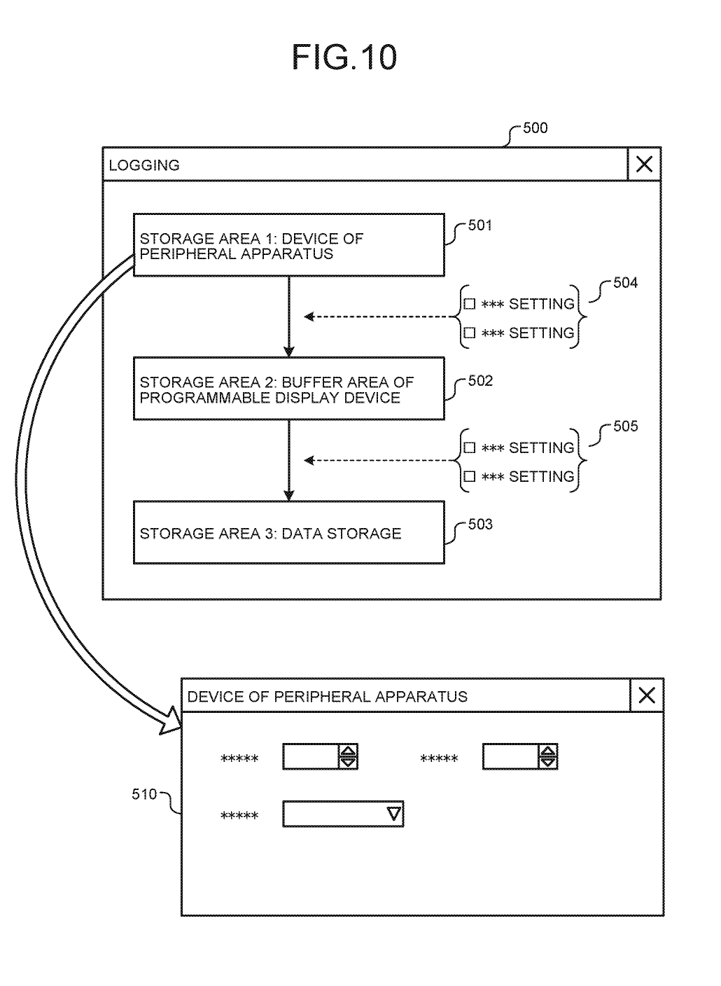

FIG. 10 is a diagram illustrating an example of the sub-function setting screen of the project-data creation device according to the second embodiment. A sub-function setting screen 500 is provided for setting the logging function, and includes a storage-area-1 setting-dialog calling button 501, a storage-area-2 setting-dialog calling button 502, and a storage-area-3 setting-dialog calling button 503. A storage area 1 is the device of the peripheral apparatus. A storage area 2 is the buffer memory of the programmable display device. A storage area 3 is the data storage. When the location of the storage-area-1 setting-dialog calling button 501 Is depressed, the wizard control unit 111a displays on the display unit 14 a setting dialog 510 related to the device of the peripheral apparatus. Similarly, when the location of the storage area 2 is clicked, the wizard control unit 111a displays on the display unit 14 a setting dialog related to the buffer memory of the programmable display device 200. When the location of the storage area 3 is clicked, the wizard control unit 111a displays on the display unit 14 a setting dialog related to the data storage.

The sub-function setting screen 500 further includes storage area-to-storage area setting fields 504 and 505. Depressing the storage area-to-storage area setting fields 504, 505 makes it possible to display, on the display unit 14, a setting dialog for incorporating data from the device of the peripheral apparatus into the buffer area of the programmable display device 200 and a setting dialog for writing data from the buffer area of the programmable display device 200 into the data storage.

In the present embodiment, regarding the sub-function involving the data flow, the setting-item dependency relation data 123 is created for each setting dialog. The highlighting-shift control unit 111b sequentially highlights the setting items in each setting dialog on the basis of the setting-item dependency relation data 123.

At the time of performing the settings related to the sub-function involving the data flow, the project-data creation device according to the second embodiment displays the setting-dialog calling buttons along the data flow during execution of the sub-function. This makes it possible to intuitively perform the settings of the sub-function.

In the present embodiment, the settings of the logging function have been described as an example. However, by displaying a sub-function setting guide screen, it is also possible to intuitively perform the settings of another function involving a data flow, such as a recipe function of incorporating data stored in the data storage into the buffer memory of the programmable display device, and thereafter writing the data into the device of the peripheral apparatus.

### INDUSTRIAL APPLICABILITY

As described above, the drawing software according to the present invention is useful to form a project-data creation device that creates project data on a programmable display device having an advanced function configured by multiple sub-functions.

### REFERENCE SIGNS LIST

10 computer, 11 CPU, 12 storage unit, 13 input unit, 14 display unit, 15 communication I/F, 20 drawing software, 111 control unit, 111a wizard control unit, 111b highlighting-shift control unit, 111c guide-display control unit, 112 display-device screen generation unit, 121 setting screen data, 122 function-dependency relation data, 122a numbers, 123 setting-item dependency relation data, 123a initial execution designation, 123b highlighted item, 123c set value, 123d next-highlighted item, 124 guide information, 200 programmable display device, 300 function-setting wizard screen, 301 tree display area, 302 description-text display area, 401 number of graphs, 402 number of points, 403 display direction, 404 drawing mode, 405 point form, 406 logging ID, 407 device setting, 408 line type, 501 storage-area-1 setting-dialog calling button, 502 storage-area-2 setting-dialog calling button, 503 storage-area-3 setting-dialog calling button, 504, 505 storage area-to-storage area setting fields, 510 setting dialog.

1. A drawing software that causes a computer including a display and a memory to function as a project-data creation device that creates project data for a programmable display device that displays a state of an external device and controls the external device, wherein
the software, when executed by the computer, causes the computer to:
store, in the memory, first information indicating a setting order of a plurality of sub-functions included in a function of the programmable display device;
store, in the memory, second information that brings each of at least one candidate set value of each setting item on a setting screen of a sub-function, into a next-highlighted item that is a setting item to be next highlighted;
display, on the display unit, a list of a plurality of sub-functions having assigned numbers based on the first information;
display, on the display unit, a setting screen of a sub-function selected from among the displayed list of the sub-functions; and
highlight a predetermined setting item on the setting screen of the sub-function and, each time a set value is set in a highlighted setting item, change on a basis of the second information a setting item to be highlighted, to a setting item that is indicated as the next-highlighted item corresponding to the candidate set value that agrees with the set value having been set, in order to sequentially highlight the respective setting items on the setting screen of the sub-function.

2. The drawing software according to claim 1, wherein
the software, when executed by the computer, causes the computer to:
store, in the memory, description information regarding each setting item on a the setting screen of a the sub-function; and
display the description information on the setting screen of the sub-function at a time of highlighting each setting item on the setting screen of the sub-function.

3. The drawing software according to claim 2, wherein the software when executed by the computer, causes the computer to set whether to highlight the setting item on the setting screen of the sub-function and whether to display the description information.

4. The drawing software according to claim 1, wherein on a setting screen of a sub-function involving data transmission and reception to and from an external device, buttons for displaying a plurality of sub-function setting dialogs on the display unit are placed along a data flow and respective setting items in the sub-function setting dialogs are sequentially highlighted on the basis of the second information.
